(19) United States
(12) Patent Application Publication
(10) Pub. No.: US 2026/0237997 A1
(43) Pub. Date: Aug. 13, 2026

(54) PROTECTION CONTROL DEVICE AND CURRENT CONTROL METHOD USING SAME

(71) Applicant: Nissan Motor Co., Ltd., Yokohama-shi, Kanagawa (JP)

(72) Inventors: Keisuke NAKANO, Kanagawa (JP); Hisakazu NARUKAMI, Kanagawa (JP); Genki KANEKO, Kanagawa (JP)

(21) Appl. No.: 19/160,059

(22) PCT Filed: Mar. 2, 2023
(86) PCT No.: PCT/JP2023/007902

§ 371 Date: Aug. 27, 2025

(51) Int. Cl. H02H 5/04

(52) U.S. Cl. CPC H02H 5/048

(57) ABSTRACT

A protection control device includes a reference temperature acquisition unit configured to acquire temperature measured with respect to a first component, as a reference temperature; a first temperature estimation unit configured to estimate temperature of the power electrical component as protection target component temperature; and a current control unit configured to control current flowing through the power electrical component, based on the estimated protection target component temperature. The first temperature estimation unit estimates the protection target component temperature, based on an accumulated value of a temporal temperature change amount of a difference between an amount of heat generation of the power electrical component, the amount of heat generation being calculated based on the current, and an amount of heat dissipation of the power electrical component, the amount of heat dissipation being calculated based on the reference temperature, in accordance with a first temperature estimation function.

### CROSS-REFERENCE TO RELATED APPLICATIONS

This application is a U.S. national stage application of International Application No. PCT/JP2023/007902, filed on Mar. 2, 2023.

### BACKGROUND

### Technical Field

The present invention relates to a protection control device and a current control method using the protection control device, and in particular to a protection control device configured to protect a power electrical component electrically connected to a battery mounted on a vehicle from over-temperature and a current control method using the protection control device.

### Background Information

On vehicles, such as an electric vehicle (EV) and a hybrid vehicle (HV), large capacity and high output batteries are mounted. Electricity output from a battery is supplied to a drive motor via some power electrical components, such as a switch, a relay, and a fuse. In such a vehicle, there is a possibility that, depending on a travel state, large current (current exceeding 1000 A) flows through the power electrical components and then generated Joule heat causes the power electrical components to burn out or melt down.

Japanese Patent Application Publication No. 2007-253735 A described below discloses a technology to temporally or chronologically calculate the substantial amount of heat generation (temperature change amount) from a difference between the amount of heat generation and the amount of heat dissipation due to current supplied to a motor and control motor output in such a way that a motor current value converges to a target current value matching estimated temperature of the motor indicated by an accumulated value obtained by accumulating the amount of heat generation.

### SUMMARY

The technology disclosed in Japanese Patent Application Publication No. 2007-253735 A has not been able to accurately estimate motor temperature because the amount of heat dissipation used for calculating the temperature change amount is calculated based on a difference between current estimated temperature of the motor and surrounding temperature (ambient temperature). In other words, since the technology disclosed in Japanese Patent Application Publication No. 2007-253735 A has not taken into consideration the amount of heat dissipation in which heat accumulated in the motor is transferred to other surrounding components (power electrical components), accuracy of the temperature estimation has not been able to be said to be sufficient.

Further, in protecting power electrical components arranged around the battery from over-temperature, it has been difficult to measure the temperature of the power electrical components by a sensor due to structural problems or the like. On the other hand, although the battery temperature is generally measured, even if estimation of temperature of the power electrical component using the measured battery temperature is attempted, it has not been possible to accurately estimate the temperature of a power electrical component since a difference in thermal capacity between the power electrical component and the battery is large.

Accordingly, an object of the present invention is to provide a protection control device and a current control method using the protection control device that are capable of more accurately estimate temperature of a component to be protected from over-temperature (hereinafter, referred to as “protection target component”).

To solve the problems described above, the present invention is configured to include the matters used to specify the invention and technical features described below.

The present invention according to one aspect is a protection control device configured to protect a power electrical component electrically connected to a battery from over-temperature. The protection control device comprises: a reference temperature acquisition unit configured to acquire temperature measured with respect to a first component to which heat generated in the power electrical component due to current flowing through the power electrical component is transferred, as a reference temperature; a first temperature estimation unit configured to estimate temperature of the power electrical component as protection target component temperature; and a current control unit configured to control current flowing through the power electrical component, based on the estimated protection target component temperature. The first temperature estimation unit estimates the protection target component temperature, based on an accumulated value of a temporal temperature change amount of a difference between an amount of heat generation of the power electrical component, the amount of heat generation being calculated based on the current, and an amount of heat dissipation of the power electrical component, the amount of heat dissipation being calculated based on the reference temperature, in accordance with a first temperature estimation function.

Further, the present invention according to another aspect is a current control method performed by a protection control device configured to control current flowing through a power electrical component due to charge and discharge of a battery. The current control method includes: acquiring temperature measured with respect to the battery as a reference temperature; estimating temperature of the power electrical component as protection target component temperature; and controlling current flowing through the power electrical component, based on the estimated protection target component temperature. Estimating temperature of the power electrical component as the protection target component temperature includes estimating the protection target component temperature, based on an accumulated value of a temporal temperature change amount of a difference between an amount of heat generation of the power electrical component, the amount of heat generation being calculated based on the current, and an amount of heat dissipation of the power electrical component, the amount of heat dissipation being calculated based on the reference temperature, in accordance with a first temperature estimation function.

It is noted that in the description of the present invention or the like, the term “means” does not simply means a physical means, but also includes a case where a function that the means has is implemented by software. In addition, a function that one means has may be achieved by two or more physical means, and functions of two or more means may be achieved by one physical means. In addition, the term “system” refers to a logical assembly of a plurality of devices (or function modules each achieving a particular function), and it does not particularly matter whether or not the respective devices or function modules are contained in a single housing.

According to the present invention, it becomes possible to estimate temperature of a protection target component more accurately and control current output to a motor according to the estimated temperature. Since therefore, current that is appropriately controlled according to the temperature of the protection target component is output to the motor, it is possible to maintain excellent traveling performance of a vehicle.

Other technical features, objects, actions and effects, and advantages of the present invention will become apparent from the following embodiments described with reference to the attached drawings. Advantageous effects described herein are merely illustrative and not restrictive, and may have another advantageous effect.

### BRIEF DESCRIPTION OF DRAWINGS

Referring now to the attached drawings which form a part of this original disclosure, illustrative embodiments are shown.

FIG. 1 is a diagram schematically illustrative of an example of a power system of a vehicle to which a protection control device according to one embodiment of the present invention is applied.

FIG. 2 is a diagram illustrative of an example of a functional model of the protection control device according to the one embodiment of the present invention.

FIG. 3 is diagrams illustrative of examples of mapping tables in the protection control device according to the one embodiment of the present invention.

FIG. 4 is a diagram illustrative of an example of a functional model of a protection control device according to another embodiment of the present invention.

FIG. 5 is graphs illustrative of examples of temporal transition of temperature of a protection target component due to use of an in-vehicle battery.

FIG. 6 is a diagram illustrative of an example of a functional model of a protection control device according to still another embodiment of the present invention.

FIG. 7 is a diagram illustrative of an example of a functional model of a protection control device according to still another embodiment of the present invention.

FIG. 8 is a diagram illustrative of an example of a functional model of a protection control device according to still another embodiment of the present invention.

### DETAILED DESCRIPTION OF EMBODIMENTS

Embodiments of the present invention will be described below with reference to the drawings. However, the embodiments to be described below are only examples, and there is no intention to exclude various modifications or application of technologies not explicitly described below. The present invention can be subjected to various modifications (such as combining embodiments) without departing from the scope of the present invention. In addition, in the following description of the drawings, the same or similar parts are designated by the same or similar reference signs. The drawings are schematic, and dimensions, ratios, or the like do not necessarily coincide with actual dimensions, ratios, or the like. There may also be portions where the dimensional relationship or the ratio differs between the drawings.

The present embodiment is characterized by calculating the amount of heat generation of a power electrical component to be protected from over-temperature, based on current flowing through the power electrical component and also calculating the amount of heat dissipation of the power electrical component based on measured temperature of a battery, calculating an accumulated value by accumulating a temporal temperature change amount of a difference between the calculated amount of heat generation and amount of heat dissipation, and estimating temperature of the power electrical component (protection target component temperature), based on the calculated accumulated value.

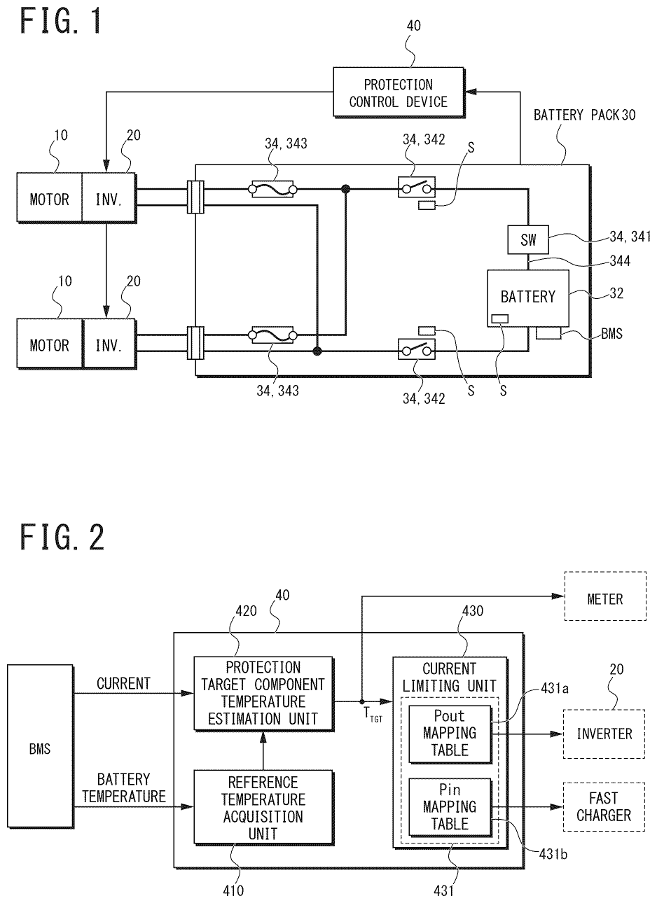

FIG. 1 is a diagram schematically illustrative of an example of a power system of a vehicle to which a protection control device according to one embodiment of the present invention is applied. As illustrated in this figure, a power system 1 of a vehicle is configured to include, for example, motors 10 to drive wheels (not illustrated), inverter circuits 20 to drive-control the motors 10, a battery pack 30, and a protection control device 40. Since the motors 10, the inverter circuits 20, and the battery pack 30 are known, description thereof will be made hereinbelow only as far as the foregoing relates to a technology associated with the present disclosure.

The battery pack 30 is configured to include, for example, a battery 32 including a group of battery cells, some power electrical components 34, and the like. Further, the battery pack 30 may include a battery management system (BMS). The battery management system BMS measures temperature of the battery 32 by a temperature sensor S and outputs the measured temperature (battery temperature T_BAT). The battery 32 is electrically connected to the inverter circuits 20 via some power electrical components 34 and supplies power required to drive the motors 10. The motors 10 are configured to include a motor 10F for driving front wheels and a motor 10R for driving rear wheels. Further, in the present example, a switch 341, relays 342, and fuses 343 are illustrated as the power electrical components 34.

The switch 341 is typically a maintenance switch used to separate the battery 32 from a wiring system at the time of maintenance. The switch 341 is an example of a power electrical component 34 that is electrically connected to the battery 32 via an interposed component 344 that is made of a conductive material and referred to as a bus bar. When a vehicle repeatedly travels at full acceleration and deceleration, a large current flows from the battery 32 to the switch 341, and the switch 341 is sometimes caused to burn out or melt down due to Joule heat generated by the large current. Therefore, in the present disclosure, the switch 341 is a component that needs to be protected from over-temperature (i.e., a protection target component) and whose temperature is to be estimated. Further, estimated temperature of the switch 341 is sometimes referred to as ‘protection target component temperature T_{TGT}’.

The protection control device 40 estimates the temperature of the switch 341 and controls an upper limit of current flowing to the inverter circuits 20 according to the estimated temperature. By this configuration, it is possible to suppress excessive current flowing through the switch 341 and prevent the switch 341 from burning out or melting down.

It is noted that, as described in other embodiments, the battery pack 30 may include a temperature sensor S that measures temperature of, for example, the relay 342, which is one of the power electrical components 34.

FIG. 2 is a diagram illustrative of an example of a functional model of the protection control device according to one embodiment of the present invention. As illustrated in this figure, the protection control device 40 includes, for example, a reference temperature acquisition unit 410, a protection target component temperature estimation unit 420, and a current limiting unit 430.

The reference temperature acquisition unit 410 acquires a reference temperature used to estimate the temperature of the switch 341 (protection target component temperature T_{TGT}). In the present embodiment, the reference temperature is battery temperature T_{BAT}. That is, the reference temperature acquisition unit 410 acquires the temperature of the battery 32 (battery temperature T_{BAT}) from the battery management system BMS.

The protection target component temperature estimation unit 420 calculates a temporal temperature change amount ΔT/Δt of the switch 341 in accordance with a predetermined temperature estimation function and estimates current temperature of the switch 341, based on an accumulated value of the calculated temperature change amount ΔT/Δt (i.e., the protection target component temperature T_{TGT}=T+ΔT_{TGT}). The protection target component temperature estimation unit 420 stores the estimated protection target component temperature T_{TGT} in a register (not illustrated) and further outputs the protection target component temperature T_{TGT} to the current limiting unit 430. The protection target component temperature T_{TGT} stored in the register is used to chronologically estimate the next protection target component temperature T_{TGT}. It is noted that, in the present disclosure, the protection target component temperature estimation unit 420 is equivalent to a first temperature estimation unit.

In general, as a temperature estimation function to estimate temperature T of a target object that generates heat due to flowing current, the following formula is known.

$$[ Math 1 ]$$

$$\frac{Δ T}{Δ t} = \frac{r}{{C}_{p}} {I}^{2} - \frac{hA}{{C}_{p}} ( T - {T}_{∞} ) \qquad Formula ( 1 )$$

In this formula, r is thermal resistance (Ω), I is current (A), Cₚ is thermal capacity (J/K), A is surface area (m²), and h is thermal conductivity (W/(m²·K)). In addition, T is current temperature, and T_{∞} is current temperature of a heat dissipation destination (heat conduction destination; for example, a surrounding environment).

In the above-described formula (1), the left-hand side indicates a temporal temperature change amount of a target object. Further, the first term on the right-hand side is a heat generation term proportional to the square of the current I, and the second term is referred to as a heat dissipation term. From the given formula, temperature T of the target object can be calculated as an accumulated value of the temporal temperature change amount.

In the present embodiment, the temperature estimation function of the protection target component temperature estimation unit 420 is defined as described below.

$$[ Math 2 ]$$

$$\frac{Δ T}{Δ t} = a \frac{r}{{C}_{p}} {I}^{2} - b \frac{hA}{{C}_{p}} ( {T}_{TGT} - {T}_{BAT} ) \qquad Formula ( 2 )$$

In this formula, r is thermal resistance (Ω) of the switch 341, I is current (A) flowing through the switch 341, Cₚ is thermal capacity (J/K) of the switch 341, A is surface area (m²) of the switch 341, and h is thermal conductivity (W/(m²·K)) of the switch 341. In addition, T_{TGT} is the current temperature of the switch 341, and T_{BAT} is the battery temperature. Further, a is a heat generation coefficient, and b is a heat dissipation coefficient.

Specifically, in the present embodiment, it is assumed that a destination to which heat of the switch 341 is transferred (heat dissipation destination) is the battery 32, and therefore, temperature of the heat dissipation destination in the heat dissipation term of the temperature estimation function expressed by the formula (2) is assumed to be the battery temperature T_{BAT}. Thus, compared with a conventional temperature estimation method that uses surrounding temperature as the reference temperature, it becomes possible to estimate the temperature of the switch 341 more accurately. Further, the heat generation coefficient a and/or the heat dissipation coefficient b can, for example, be dynamically adjusted according to a current value of the current flowing through the switch 341. For example, the protection control device 40 includes a coefficient adjustment unit (not illustrated), and the coefficient adjustment unit adjusts a value of the heat generation coefficient a in an increasing manner when a large current value (for example, 1000 A or more) is detected. Alternatively, the heat generation coefficient a and/or the heat dissipation coefficient b may, for example, be dynamically adjusted according to the accumulated value of the temperature change amount ΔT/Δt, the battery temperature T_{BAT}, and/or ambient temperature measured by an environmental sensor (not illustrated). By this configuration, it becomes possible to perform more accurate temperature estimation with respect to a power electrical component 34 (the switch 341) and protect the switch 341 from over-temperature without restricting output of excessive current.

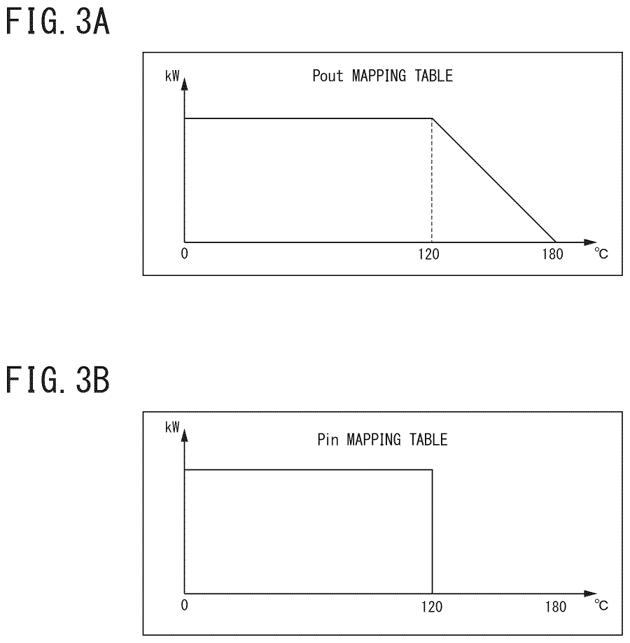

The current limiting unit 430 determines an upper limit of output current according to the temperature T_{TGT} of the switch 341. The current limiting unit 430 includes, for example, mapping tables 431 that accept temperature T_{TGT} as input and output the upper limit of the output current. In the present disclosure, the mapping tables 431 are configured to include a Pout mapping table 431a for determining an upper limit of output current flowing from the battery 32 to the inverter circuits 20 in a normal travel mode and a Pin mapping table 431b for determining an upper limit of output current flowing from a charger to the battery 32 in a charging mode. For example, FIG. 3 is diagrams illustrative of examples of the mapping tables that the current limiting unit 430 retains. Specifically, FIG. 3A illustrates an example of the Pout mapping table 431a, and FIG. 3B illustrates an example of the Pin mapping table 431b. The current limiting unit 430 switches the mapping tables 431 depending on the normal travel mode or the charging mode. The current limiting unit 430 notifies, in the normal travel mode, the inverter circuits 20 of the upper limit of the output current determined according to the temperature T of the switch 341.

As described above, according to the present embodiment, since the protection control device 40 estimates the current temperature T of the switch 341 from the accumulated value of the temperature change amount in accordance with a predetermined temperature estimation function with the battery temperature T_{BAT} as a reference temperature and controls the upper limit of the current flowing to the inverter circuits 20 according to the estimated temperature T, it is possible to suppress excessive current from flowing through the switch 341 and prevent the switch 341 from burning out or melting down.

The present embodiment is a variation of the above-described embodiment and is characterized by estimating, in estimating temperature of a power electrical component (protection target component temperature T_{TGT}), temperature of an interposed component (interposed component temperature) to which heat generated in the protection target component is transferred, based on measured battery temperature and calculating the amount of heat dissipation of the protection target component in a temperature estimation function, based on the estimated interposed component temperature.

In the present disclosure, an interposed component 344 is a component that is interposed between a switch 341 that is a protection target component and a battery 32 that is a target the temperature of which is to be measured as a reference temperature. The interposed component 344 is capable of transferring heat generated in the switch 341 by current flowing due to charge and discharge of the battery 32, to the battery 32. In the present embodiment, it is assumed that the interposed component 344 is a so-called bus bar that electrically connects the switch 341 and a terminal of the battery 32 (see FIG. 1).

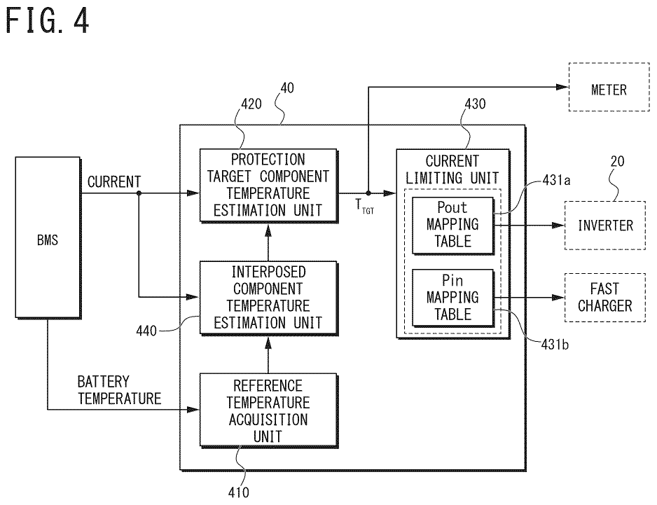

FIG. 4 is a diagram illustrative of an example of a functional model of a protection control device according to another embodiment of the present invention. As illustrated in the drawing, a protection control device 40 of the present embodiment includes, for example, a reference temperature acquisition unit 410, a protection target component temperature estimation unit 420, a current limiting unit 430, and an interposed component temperature estimation unit 440. That is, the protection control device 40 of the present embodiment differs from the above-described protection control device 40 of the first embodiment in that the protection control device 40 of the present embodiment includes the interposed component temperature estimation unit 440. In the present disclosure, the interposed component temperature estimation unit 440 is equivalent to a second temperature estimation unit. Hereinafter, with regard to the same constituent elements as those in the first embodiment, descriptions thereof will be appropriately omitted.

The protection target component temperature estimation unit 420, as described above, calculates a temporal temperature change amount ΔT/Δt of the switch 341 in accordance with a first temperature estimation function and estimates current temperature T of the switch 341, based on an accumulated value of the calculated temperature change amount ΔT/Δt. In the present embodiment, the first temperature estimation function of the protection target component temperature estimation unit 420 differs from that of the protection target component temperature estimation unit 420 in the first embodiment in using, as a reference temperature, temperature of the interposed component 344 (interposed component temperature T_{ITP}) estimated by the interposed component temperature estimation unit 440, which will be described later.

Specifically, in the present embodiment, the first temperature estimation function is defined as described below.

$$[ Math 3 ]$$

$$\frac{Δ T}{Δ t} = a \frac{r}{{C}_{p}} {I}^{2} - b \frac{hA}{{C}_{p}} ( {T}_{TGT} - {T}_{ITP} ) \qquad Formula ( 3 )$$

In this formula, r is thermal resistance (Ω) of the switch 341, I is current (A) flowing through the switch 341, Cₚ is thermal capacity (J/K) of the switch 341, A is surface area (m²) of the switch 341, and h is thermal conductivity (W/(m²·K)) of the switch 341. In addition, T_{TGT} is current temperature of the switch 341, and T_{ITP} is the temperature of the interposed component 344 (interposed component temperature). Further, a is a heat generation coefficient (first heat generation coefficient), and b is a heat dissipation coefficient (first heat dissipation coefficient).

As can be apparent from the above-described formula, in the present embodiment, it is assumed that a destination to which heat of the switch 341 is transferred is the interposed component 344, and heat dissipation destination temperature in the heat dissipation term of the first temperature estimation function in the formula (3) is assumed to be the interposed component temperature T_{ITP}. The protection target component temperature estimation unit 420 stores the protection target component temperature T_{TGT} estimated in accordance with the first temperature estimation function in a register (not illustrated) and also outputs the protection target component temperature T_{TGT} to the current limiting unit 430. The protection target component temperature T_{TGT} stored in the register is used to chronologically estimate the next protection target component temperature T_{TGT}.

The interposed component temperature estimation unit 440 calculates a temporal temperature change amount of the interposed component 344 in accordance with a second temperature estimation function and estimates current temperature T_{ITP} of the interposed component 344, based on an accumulated value of the calculated temperature change amount.

The second temperature estimation function is defined as described below.

$$[ Math 4 ]$$

$$\frac{Δ {T}_{ITP}}{Δ t} = \frac{r}{{C}_{p}} {I}^{2} - \frac{hA}{{C}_{p}} ( {T}_{ITP} - {T}_{BAT} ) \qquad Formula ( 4 )$$

In this formula, r is thermal resistance (Ω) of the interposed component 344, I is current (A) flowing through the interposed component 344, Cₚ is thermal capacity (J/K) of the interposed component 344, A is surface area (m²) of the interposed component 344, and h is thermal conductivity (W/(m²·K)) of the interposed component 344. In addition, T_{ITP} is current temperature of the interposed component 344, and T_{BAT} is the battery temperature. Note that although not indicated in the formula, the heat generation term and the heat dissipation term may include a heat generation coefficient a′ (second heat generation coefficient) and a heat dissipation coefficient b′ (second heat dissipation coefficient) as described above.

As can be apparent from the above-described formula, it is assumed that a destination to which heat of the interposed component 344 is transferred is the battery 32, and temperature of the heat dissipation destination in the heat dissipation term of the second temperature estimation function expressed by the formula (4) is assumed to be the battery temperature T_{BAT}. The interposed component temperature estimation unit 440 stores the interposed component temperature T_{ITP} estimated in accordance with the second temperature estimation function in a register (not illustrated) and also outputs the interposed component temperature T_{ITP} to the protection target component temperature estimation unit 420. The interposed component temperature T_{ITP} stored in the register is used to chronologically estimate the next interposed component temperature T_{ITP}. By configuration, the protection target component temperature estimation unit 420 estimates the protection target component temperature T_{TGT} using the estimated interposed component temperature T_{ITP} as a reference temperature.

Further, the second heat generation coefficient a′ and/or the second heat dissipation coefficient b′ can, for example, also be dynamically adjusted according to a current value of the current flowing through the switch 341. Alternatively, the second heat generation coefficient a′ and/or the second heat dissipation coefficient b′ may, for example, be dynamically adjusted according to the accumulated value of the temperature change amount ΔT/Δt, the battery temperature T_{BAT}, and/or ambient temperature measured by an environmental sensor (not illustrated). A coefficient adjustment unit (not illustrated) of the protection control device 40, for example, adjusts the second heat generation coefficient a′ and/or the second heat dissipation coefficient b′ according to the current value of the current, the accumulated value of the temperature change amount ΔT/Δt, the battery temperature T_{BAT}, and/or the ambient temperature measured by the environmental sensor. By this configuration, it becomes possible to perform more accurate temperature estimation with respect to a power electrical component 34 (the switch 341) and protect the switch 341 from over-temperature without restricting output of excessive current.

As described above, according to the present embodiment, since the protection control device 40 first estimates the interposed component temperature T_{ITP} in accordance with the second temperature estimation function with the battery temperature T_{BAT} as the reference temperature and next estimates the temperature T of the switch 341 in accordance with the first temperature estimation function with the estimated interposed component temperature T_{ITP} as the reference temperature, in consideration of a structural relationship among the battery 32, the switch 341, and the interposed component 344, the protection control device 40 becomes capable of estimating the temperature T_{TGT} of the switch 341 more accurately. Since because of this capability, the protection control device 40 controls the upper limit of the current flowing to the inverter circuits 20 according to the protection target component temperature T_{TGT}, it is possible to suppress excessive current from flowing through the switch 341 and prevent the switch 341 from burning out or melting down.

The present embodiment is a variation of the above-described embodiments and is characterized by calculating, in estimating temperature of a power electrical component (protection target component temperature), an initial value of the protection target component temperature at a time point when a vehicle is brought into an active state, based on the protection target component temperature estimated immediately before the vehicle was brought into a sleep state, time during which the vehicle has been in the sleep state, and current battery temperature.

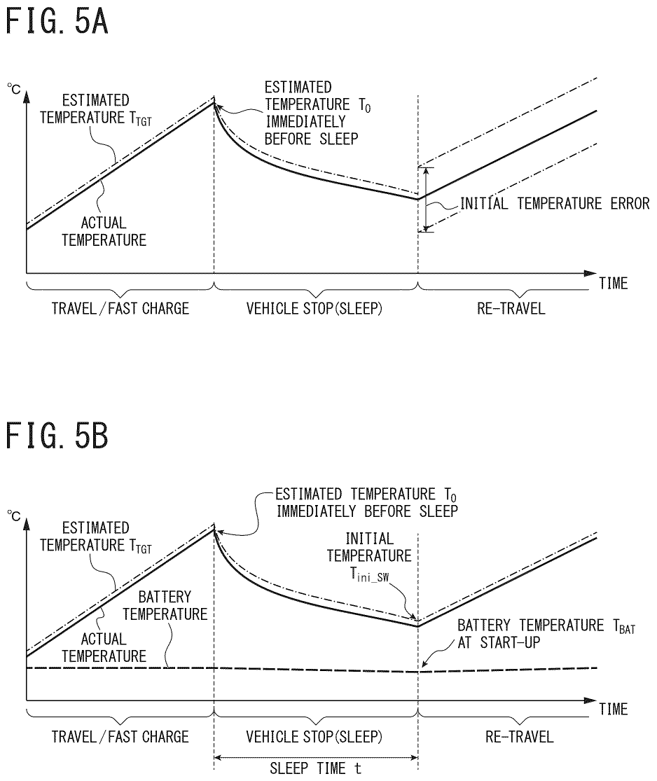

For example, as illustrated in FIG. 5A, while the protection target component generates heat due to current flowing from a battery 32 while the vehicle is traveling (or flowing to the battery 32 during charging) and the protection target component temperature gradually rises when the amount of heat generation exceeds the amount of heat dissipation, it becomes difficult to estimate temperature using the current when, for example, the vehicle comes to a stop and the battery 32, a protection control device 40, and the like are brought into the sleep state. Therefore, if, at a time point when the protection control device 40 is subsequently brought into the active state again, protection target component temperature T_{TGT} is estimated using, for example, temperature T_{BAT} of the battery 32 as a reference temperature, estimation error occurs due to deviation of the estimated protection target component temperature T_{TGT} from actual temperature. Therefore, in the present embodiment, an initial value of the protection target component temperature T_{TGT} is calculated based on the protection target component temperature calculated immediately before the protection control device 40 was brought into the sleep state, time during which the protection control device 40 has been in the sleep state, and current temperature T_{BAT} of the battery 32, and the calculated initial value is applied to a temperature estimation function.

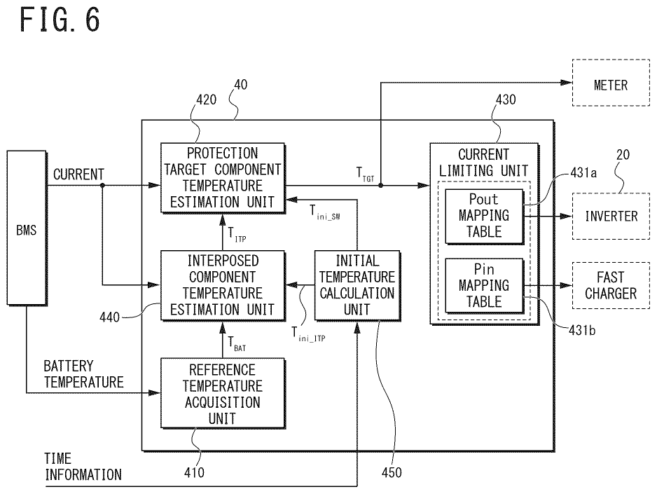

FIG. 6 is a diagram illustrative of an example of a functional model of a protection control device according to still another embodiment of the present invention. As illustrated in this figure, the protection control device 40 of the present embodiment is configured to include, for example, a reference temperature acquisition unit 410, a protection target component temperature estimation unit 420, an interposed component temperature estimation unit 440, a current limiting unit 430, and an initial temperature calculation unit 450. That is, the protection control device 40 of the present embodiment differs from the above-described protection control device 40 of the second embodiment in that the protection control device 40 of the present embodiment includes the initial temperature calculation unit 450. Hereinafter, with regard to the same constituent elements as those in the above-described embodiments, descriptions thereof will be appropriately omitted.

In this figure, the initial temperature calculation unit 450 calculates an initial temperature Tᵢₙᵢ of a switch 341. That is, the initial temperature calculation unit 450 calculates, at the start of estimation of the initial temperature Tᵢₙᵢ of the switch 341, an initial temperature T_{ini_SW} of the switch 341 in accordance with an initial temperature calculation function, based on the protection target component temperature T_{TGT} immediately before the estimation starts, sleep time t_{Sleep} that indicates time during which the protection control device 40 has been in the sleep state, and battery temperature T_{BAT}. The sleep time t is calculated using, for example, time information acquired from a not-illustrated in-vehicle control device.

In the present embodiment, the initial temperature calculation function is defined as described below.

$$[ Math 5 ]$$

$${T}_{ini \_ SW} = {T}_{BAT} + ( {T}_{TGT 0} - {T}_{BAT} ) exp ( - \frac{1}{τ} {t}_{Sleep} ) \qquad Formula ( 5 )$$

In this formula, T_{BAT} is the battery temperature, T_{TGT0} is temperature of the switch 341 calculated immediately before the protection control device 40 was brought into the sleep state, t_{Sleep} is the sleep time, and t is a predetermined time constant.

The initial temperature calculation unit 450, when a power system 1 is started up, acquires the protection target component temperature stored in a register and also acquires the battery temperature from a battery management system BMS, and further acquires the sleep time t_{Sleep} from the in-vehicle control device, calculates the initial temperature T_{ini_SW} in accordance with the above-described initial temperature calculation function, and outputs the calculated initial temperature T_{ini_SW} to the protection target component temperature estimation unit 420. By this configuration, the protection target component temperature estimation unit 420 becomes capable of estimating the protection target component temperature T_{TGT} more accurately using the protection target component initial temperature T_{ini_SW}, even when the protection control device 40 transitions from the sleep state to the active state, as illustrated in, for example, FIG. 5B.

In addition, the initial temperature calculation unit 450 may calculate an initial temperature of the interposed component 344 (interposed component initial temperature T_{ini_ITP}) after the power system 1 is started up. The interposed component initial temperature Tᵢₙᵢ ITP is, for example, similarly calculated by using, instead of T_{TGT0}, temperature T_{ITP0} of the interposed component 344 immediately before the protection control device 40 was brought into the sleep state in the above-described initial temperature calculation function. The initial temperature calculation unit 450 outputs the calculated interposed component initial temperature T_{ini_ITP} to the interposed component temperature estimation unit 440. Because of this configuration, the interposed component temperature estimation unit 440 becomes capable of estimating the interposed component temperature T_{ITP} more accurately using the interposed component initial temperature T_{ini_ITP} even when the protection control device 40 transitions from the sleep state to the active state, and therefore, the protection target component temperature estimation unit 420 becomes capable of estimating the protection target component temperature T_{TGT} more accurately.

As described above, according to the present embodiment, since the protection control device 40 calculates, when the protection control device 40 is brought into the sleep state and subsequently brought into the active state, an initial temperature of the protection target component temperature T_{TGT} at a time point when the protection control device 40 is brought into the active state, based on the estimated protection target component temperature T_{TGT0} immediately before the protection control device 40 was brought into the sleep state, the time t during which the protection control device 40 has been in the sleep state, and the current battery temperature T_{BAT} and uses the calculated initial temperature for a predetermined temperature estimation function, the protection control device 40 becomes capable of estimating the temperature T_{TGT} of the switch 341 more accurately. In addition, since the protection control device 40 similarly calculates the initial temperature of the protection target component temperature T_{TGT} at a time point when the protection control device 40 is brought into the active state, based on the estimated interposed component temperature T_{ITP0} immediately before the protection control device 40 was brought into the sleep state, the time t during which the protection control device 40 has been in the sleep state, and the current battery temperature T_{BAT} and uses the calculated initial temperature for the predetermined temperature estimation function, the protection control device 40 becomes capable of more accurately estimating the temperature T_{ITP} of the interposed component 344 for estimating the temperature T_{TGT} of the switch 341. Since the protection control device 40 controls the upper limit of the current flowing to the inverter circuits 20 according to the protection target component temperature T_{TGT} estimated in this way, it is possible to suppress excessive current from flowing through the switch 341 and prevent the switch 341 from burning out or melting down.

The present embodiment is a variation of the above-described embodiments and is characterized by estimating protection target component temperature, based on a structural relationship of interposed components interposed between a battery and a power electrical component that is a protection target component, using a predetermined temperature estimation function formed in a plurality of stages.

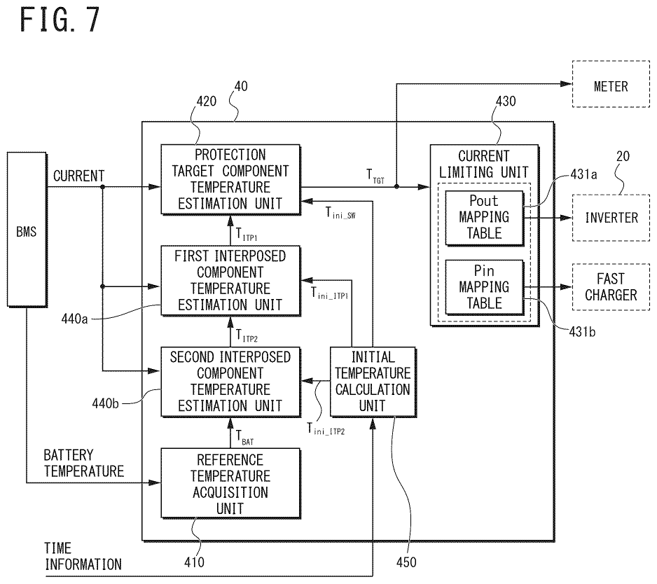

FIG. 7 is a diagram illustrative of an example of a functional model of a protection control device according to still another embodiment of the present invention. As illustrated in this figure, a protection control device 40 of the present embodiment is configured to include, for example, a reference temperature acquisition unit 410, a protection target component temperature estimation unit 420, a current limiting unit 430, a first interposed component temperature estimation unit 440a, and a second interposed component temperature estimation unit 440b. That is, the protection control device 40 of the present embodiment differs from the protection control devices 40 of the above-described embodiments in that the protection control device 40 of the present embodiment includes a plurality of interposed component temperature estimation units 440. Hereinafter, with regard to the same constituent elements as those in the above-described embodiments, descriptions thereof will be appropriately omitted.

In this figure, although the first interposed component temperature estimation unit 440a and the second interposed component temperature estimation unit 440b are basically the same as the interposed component temperature estimation units 440 described in the above-described embodiments, temperature estimation functions of the first interposed component temperature estimation unit 440a and the second interposed component temperature estimation unit 440b have different coefficients from each other depending on components or portions serving as targets the temperatures of which are to be estimated. In the present example, the second interposed component temperature estimation unit 440b estimates interposed component temperature T_{ITP2} in accordance with a temperature estimation function with battery temperature T_{BAT} as a reference temperature, and next, the first interposed component temperature estimation unit 440a estimates interposed component temperature T_{ITP1} in accordance with a temperature estimation function with the estimated interposed component temperature T_{ITP2} as a reference temperature. Then, the protection target component temperature estimation unit 420 estimates temperature T of a switch 341 in accordance with a temperature estimation function with the estimated interposed component temperature T_{ITP1} as a reference temperature and outputs the estimated temperature T to the current limiting unit 430.

It is noted that, as described above, the initial temperature calculation unit 450 calculates initial temperature of each component or portion serving as a target the temperature of which is to be estimated at a time point when the protection control device 40 is brought into a sleep state and subsequently brought into an active state, and outputs the calculated initial temperature to a corresponding temperature estimation unit.

As described above, according to the present embodiment, since the protection control device 40 uses a predetermined temperature estimation function formed in a plurality of stages in consideration of a structural relationship between the battery 32 and the switch 341, the protection control device 40 becomes capable of estimating temperature T_{TGT} of the switch 341 more accurately. Since the protection control device 40 controls the upper limit of the current flowing to the inverter circuits 20 according to the temperature T_{TGT} estimated in this way, it is possible to suppress excessive current from flowing through the switch 341 and prevent the switch 341 from burning out or melting down.

The present embodiment is a variation of the above-described embodiments and is characterized by estimating, in estimating temperature of a protection target component (protection target component temperature), the temperature of the protection target component (protection target component temperature), based on temperature measured with respect to another related power electrical component (related power electrical component).

As described above, since temperature of a switch 341 that is a target the temperature of which is to be estimated is structurally difficult to actually measure by a temperature sensor, the temperature of the switch 341 is estimated in accordance with a predetermined temperature estimation function with temperature of a battery 32 that can be measured as a reference temperature. On the other hand, some of other related power electrical components 34 around the switch 341 allow temperature thereof to be actually measured by temperature sensors because of the structure thereof. Therefore, in the present embodiment, in estimating temperature T of the switch 341, temperature of another power electrical component 34 is estimated in accordance with a predetermined temperature estimation function with, instead of battery temperature T_{BAT}, temperature of a related power electrical component 34 that is measured by a temperature sensor S as a reference temperature, and temperature of a protection target component is estimated based on the estimated temperature of the related power electrical component. For example, a relay 342 or the like is an example of the other related power electrical components 34.

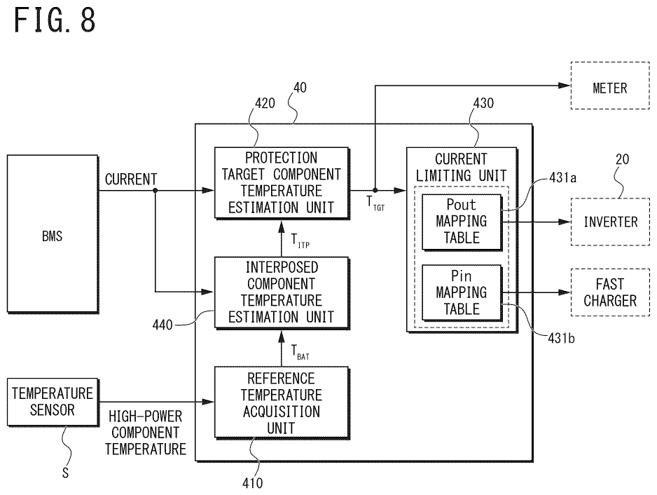

FIG. 8 is a diagram illustrative of an example of a functional model of a protection control device according to still another embodiment of the present invention. As illustrated in the drawing, a protection control device 40 of the present embodiment includes, for example, a reference temperature acquisition unit 410, a protection target component temperature estimation unit 420, a current limiting unit 430, and an interposed component temperature estimation unit 440. That is, the protection control device 40 of the present embodiment is the same as the protection control devices 40 of the above-described embodiments with the exception that the reference temperature acquisition unit 410 acquires temperature of another related power electrical component 34 measured by the temperature sensor S. Although in the drawing, the protection control device 40 of the present embodiment is illustrated as a variation of the protection control device 40 described in the above-described second embodiment (see FIG. 4), the protection control device 40 of the present embodiment may be, without being limited thereto, a protection control device 40 obtained by modifying the protection control device 40 described in one of the other embodiments.

As described above, according to the present embodiment, since the protection control device 40 estimates current temperature T of the switch 341 from an accumulated value of a temperature change amount in accordance with a predetermined temperature estimation function with related power electrical component temperature as a reference temperature and controls an upper limit of current flowing to inverter circuits 20 according to the estimated temperature T, it is possible to suppress excessive current from flowing through the switch 341 and prevent the switch 341 from burning out or melting down.

The above-described embodiments are examples for describing the present invention and are not intended to limit the present invention only to the embodiments. The present invention can be implemented in a variety of modes without departing from the scope and spirit of the present invention

For example, in the method disclosed herein, the steps, operations, or functions may be implemented concurrently or in different orders, as long as there is no inconsistency in the result. The described steps, operations, and functions have been provided as just examples, and in the scope without departing from the spirit of the present invention, some of the steps, operations, and functions can be omitted or can be combined with each other into one, and other steps, operations, or functions may be added.

Further, although a variety of embodiments are disclosed herein, a particular feature (technical matter) in an embodiment can be appropriately improved, and therewith, can be added to an alternative embodiment or can be replaced by the particular feature in the alternative embodiment, and such modes also fall within the spirit of the present invention.

1. A protection control device for protecting a power electrical component electrically connected to a battery from over-temperature, the protection control device comprising:
a reference temperature acquisition unit configured to acquire temperature measured with respect to a first component to which heat generated in the power electrical component due to current flowing through the power electrical component is transferred, as a reference temperature, the first component being the battery;
a first temperature estimation unit configured to estimate temperature of the power electrical component as protection target component temperature; and
a current control unit configured to control current flowing through the power electrical component, based on the estimated protection target component temperature,
wherein the first temperature estimation unit estimates the protection target component temperature, based on an accumulated value of a temporal temperature change amount of a difference between an amount of heat generation of the power electrical component, the amount of heat generation being calculated based on the current and an amount of heat dissipation of the power electrical component, the amount of heat dissipation being calculated based on the reference temperature, in accordance with a first temperature estimation function.

2. (canceled)

3. The protection control device according to claim 1, wherein
the first temperature estimation function includes a first heat generation coefficient and a first heat dissipation coefficient, and
the protection control device further includes a coefficient adjustment unit configured to adjust the first heat generation coefficient and the first heat dissipation coefficient according to a value of the current flowing through the power electrical component.

4. The protection control device according to claim 3, wherein
the first temperature estimation unit adjusts the first heat generation coefficient and the first heat dissipation coefficient according to the accumulated value, the reference temperature, and ambient temperature output by an environmental sensor.

5. The protection control device according to claim 1, further comprising
a second temperature estimation unit configured to estimate temperature of an interposed component interposed between the battery and the power electrical component and to which heat generated in the power electrical component is transferred, as interposed component temperature,
wherein the second temperature estimation unit estimates the interposed component temperature, based on an accumulated value of a temporal temperature change amount of a difference between the amount of heat generation calculated based on the current and an amount of heat dissipation of the interposed component, the amount of heat dissipation being calculated based on the reference temperature, in accordance with a second temperature estimation function, and
the first temperature estimation unit calculates the amount of heat dissipation of the power electrical component, based on the estimated interposed component temperature.

6. The protection control device according to claim 5, further comprising
an initial temperature calculation unit configured to calculate initial temperature of the protection target component temperature,
wherein the initial temperature calculation unit calculates, at a time of starting estimation of the protection target component temperature, the initial temperature, based on sleep time indicating time during which the protection control device is in a sleep state, the protection target component temperature calculated immediately before the protection control device is brought into a sleep state, and temperature of the battery.

7. The protection control device according to claim 5, further comprising
a plurality of the second temperature estimation units,
wherein each of the plurality of second temperature estimation units calculates an amount of heat generation and an amount of heat dissipation of the interposed component in accordance with the second temperature estimation function based on a structural relationship of the interposed component interposed between the battery and the power electrical component.

8. The protection control device according to claim 5, wherein
the second temperature estimation function includes a second heat generation coefficient and a second heat dissipation coefficient, and
the protection control device further includes a coefficient adjustment unit configured to adjust each of the second heat generation coefficient and the second heat dissipation coefficient according to a value of the current flowing through the power electrical component.

9. The protection control device according to claim 8, wherein
the coefficient adjustment unit adjusts the second heat generation coefficient and the second heat dissipation coefficient according to the accumulated value, the reference temperature, and ambient temperature output by an environmental sensor.

10. The protection control device according to claim 5, wherein
the first component to which heat generated in the power electrical component is transferred includes another related power electrical component other than the battery.

11. A current control method performed by a protection control device configured to control current flowing through a power electrical component due to charge and discharge of a battery, the current control method comprising:
acquiring temperature measured with respect to the battery to which heat generated in the power electrical component due to current flowing through the power electrical component is transferred, as a reference temperature;
estimating temperature of the power electrical component as protection target component temperature; and
controlling current flowing through the power electrical component, based on the estimated protection target component temperature,
wherein estimating temperature of the power electrical component as the protection target component temperature includes estimating the protection target component temperature, based on an accumulated value of a temporal temperature change amount of a difference between an amount of heat generation of the power electrical component, the amount of heat generation being calculated based on the current, and an amount of heat dissipation of the power electrical component, the amount of heat dissipation being calculated based on the reference temperature, in accordance with a first temperature estimation function.
